(19) United States
(12) Patent Application Publication
(10) Pub. No.: US 2008/0230625 A1
(43) Pub. Date: Sep. 25, 2008

(54) Spraying Apparatus

(76) Inventor: Timothy Williams, Clyde (NZ)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 10/598,378

(22) PCT Filed: Mar. 2, 2005
(86) PCT No.: PCT/IB2005/050756

§ 371 Date: Aug. 25, 2006

(30) Foreign Application Priority Data
Mar. 2, 2004 (NZ) 531536

(51) Int. Cl. B05B 1/20; B05B 1/32; B05B 1/16

(52) U.S. Cl. 239/76; 239/268

(57) ABSTRACT

A spray bar typically utilised for the application of fluids such as hot bitumen onto an adjacent surface has an inner tube (2) which is rotatable relative to an outer tube (17) byway of an actuator (24). The outer tube (17) has various spray nozzles (21) which are designed to deliver fluid fed to the spray bar through a fluid supply passage (3), onto the adjacent surface. The rate of flow to each nozzle is controlled by a series of corresponding apertures in the inner tube (2) and the outer tube (17) which are moved into or out of alignment by rotation of the inner tube relative to the outer tube via the actuator (24). By providing different patterns of apertures corresponding to different nozzles (21) it is possible to achieve altering spray patterns by rotation of the inner tube relative to the outer tube into predetermined orientations. The spray bar according to the invention also has the advantage over the prior art of simplified actuation controls and more robust and reliable construction.

### FIELD OF THE INVENTION

This invention relates to improvements in or relating to spraying apparatus, and more specifically, but not exclusively, relates to improvements in multiple spray head valve control means.

One particular application of the invention, without limitation as to the purpose to which the invention may be put, is in the field of spraying liquids having a high level of variability of viscosity dependant on temperature, such as bitumen.

### BACKGROUND OF THE INVENTION

Bitumen is generally sprayed onto compacted road bedding material at one or more stages during road construction and/or repair. Typically, this method is performed at least prior to top surfacing of the road with macadam or like surface finishing. Commonly, the bitumen is sprayed via spray bars mounted off the rear or extending from the sides of a tanker truck which incorporates a heated tank to maintain the fluidity of the bitumen. The one or more spray bars incorporate a plurality of spray nozzles through which bitumen pumped from the heated tank is ejected onto the road bed.

There are various problems associated with existing spray bar setups. For example, it is generally desirable to be able to adjust the volume flow rate of the bitumen. This is so, not only because of the variability of the viscosity with temperature, which affects the spray flow rate through all of the spray nozzles, but also as between the nozzles. This latter point being to accommodate, for example, greater or lesser volume requirements at, say, the point at which the vehicle wheels pass over, or if multiple overlapping passes are required, so that there is not an unnecessary build up of bitumen. While known spray bar arrangements can accommodate this, the desired result is time consuming and labour intensive to achieve, as each spray nozzle must be individually adjusted while the vehicle is stopped. Further, it is not generally possible to make adjustments to the flow rate while the vehicle is moving, or if there is a variation in the bitumen viscosity during the course of application.

It is therefore an object of the present invention to provide an improved spray bar apparatus which overcomes at least some of the abovementioned deficiencies of existing apparatus, or which at least provides the public with a useful choice.

### SUMMARY OF THE INVENTION

In its broadest aspect the invention provides a spray bar having a nested pair of tubes, namely an inner tube and an outer tube, there being at least one aperture through the wall of the inner tube and a corresponding aperture in the wall of the outer tube arranged such that the inner tube aperture and the outer tube aperture can be caused to align, a spray nozzle being mounted on the outer wall of the outer tube in communication with the aperture of the outer tube, the interior of the inner tube providing, in use, a pathway for a fluid, and an actuator means arranged to cause the inner tube to move relative to the outer tube thereby causing the apertures in the inner and outer tubes to move into and out of alignment.

Preferably, the inner and outer tubes have multiple corresponding apertures spaced along their respective lengths, with a spray nozzle associated with each aperture in the outer tube.

Desirably, the spray bar further includes a return pathway for fluid that does not pass out through the spray nozzles in use, enabling the fluid to circulate.

In one form of the invention, the apertures in the outer tube are substantially the same size and shape, and arc substantially equi-spaced in a common axial plane along the length of the spray bar. Optimally, the apertures in the inner tube are of various sizes and shapes and can be located in different axial planes.

In a more preferred form, the invention provides a spray bar having an inner tube through which a fluid can pass, said inner tube having at least one aperture in the wall thereof, a disc-like rotor mounted on said inner tube at said aperture, said rotor having a port extending radially from said aperture to the outer circumference of said rotor, said rotor being rotationally fixed onto the first tube, an annular stator having an internal configuration substantially corresponding to the outer circumference of the rotor so as to receive and engage with said rotor, said stator having a port extending radially outwardly from its inner circumference to its outer circumference, said stator port being capable of alignment with the rotor port, an outer tube surrounding said stator and being fixed thereto coaxially with the inner tube, said outer tube having an aperture therethrough in alignment with said stator port, a spray nozzle attached to the outer tube in alignment with the stator port so that in use a fluid can pass through, and an actuator to rotate the first tube relative to the second tube thereby moving the rotor port and the stator port into and out of alignment.

Preferably, there are multiple spray nozzles and corresponding rotor and stator ports disposed along the length of the spray bar.

Desirably, the rotors are keyed to the first tube to prevent rotation, but are substantially free floating along the length of the first tube, axially located via spring means.

Preferably, the outer periphery of the rotor and the inner face of the stator are conical, and the spring means is configured and arranged to pressure the rotor and the stator into engagement.

Advantageously, the stators do not occupy the entire cross section of the outer tube, thereby providing a return flow path for unused fluid back along the length of the second tube.

Optionally, any stator and rotor combination has two or more ports, either offset radially, or offset longitudinally.

Conveniently, the spray bar has multiple rotor/stator combinations, with some rotors having a different port dimensions than other rotors such that partial rotation of the inner tube can bring some of the rotor ports out of alignment with their corresponding stator port, but other rotor ports will remain in alignment with their corresponding stator ports.

### BRIEF DESCRIPTION OF THE DRAWINGS

A preferred form of the invention will now be described with reference to the accompanying drawings. The drawings comprise FIGS. 1 to 8 as follows:

FIG. 1: is a perspective view of a spraying device according to the present invention;

FIG. 2: is a perspective view of the device of FIG. 1 with the outer tube, stators and associated spring gear removed for clarity;

FIG. 3: is a perspective view of a section of the spray device of FIG. 1 with the outer tube removed, but with the stators, spring gear and associated spray nozzles in place;

FIG. 4: is a perspective view of a preferred embodiment of the device according to the present invention showing the distal end with the outer tube removed;

FIG. 5: is a further perspective view of the device of FIG. 4, but partially disassembled;

FIG. 6: is a perspective view of a stator and rotor assembly for use in the device of FIG. 4;

FIG. 7: is a perspective view of an alternative form of stator typically used in the centre of the spray bar; and

FIG. 8: is a perspective exploded view of the rotor and stator combination shown in FIG. 6.

### DETAILED DESCRIPTION OF PREFERRED EMBODIMENTS OF THE INVENTION

Referring to the drawings, a spray bar according to a preferred form of the invention is illustrated and generally indicated at 1.

The spray bar 1 has an inner tube 2 which defines a fluid supply passage 3. The tube 2 has a plurality of inner tube apertures 4 (not shown) equi-spaced along its length. Mounted on the tube 2, at locations corresponding to the inner tube apertures are rotors 5. The rotors 5 are prevented from rotating about the tube 2 by way of a keying arrangement known in the art. However, the rotors 5 are able to slide or float longitudinally along the length of the tube 2.

Each of the rotors 5 is substantially disc shaped, and having an outer circumferential face 6 which is bevelled so that each rotor 5 is substantially frusto conical. Each rotor 5 further includes a central aperture 7 to enable the rotor 5 to be mounted onto the tube 2, and has a port 8 running radially from the central aperture 7 out to the circumferential face 6. The port 8 can be of various shapes or sizes, as illustrated most clearly in FIG. 2.

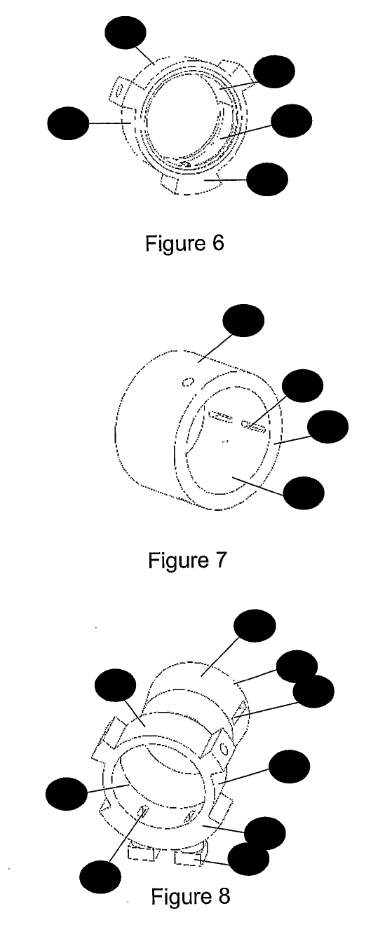

Directly surrounding each rotor 5 is a stator 9. Various individual stator 9 configurations are illustrated in FIGS. 6 to 8. FIGS. 3 and 8 in particular illustrate the interrelationship between the rotor 5 and stator 9.

Each stator 9 is substantially annular, having an inner face 10 and an outer face 11. The inner face 10 is bevelled to a frusto conical shape to co-operate and engage with the circumferential face 6 of a said rotor 5. Preferably the outer face 11 of the stator 9 has sectors 12 which are of reduced radial dimension. Each stator 9 has at least one port 13 extending between the inner face 10 and the outer face 11. This port 13 is adapted in use to be alignable with the port 8 of the corresponding rotor 5. As illustrated in FIGS. 7 and 8, there may be two ports 13. And as illustrated in FIG. 6, the dimensions of the port 13 at the inner face 10 can be greater than the dimensions of the port 13 at the outer face 11.

As illustrated in FIG. 3, springs 14 are provided between adjacent pairs of stators 9 and rotors 5. Each spring 14 has a first end 15 which engages the rotor 5 of one rotor/stator pair and another end 16 which engages the stator 9 of an adjacent pair, thereby applying pressure to biase the circumferential face 6 of the rotor 5 and the inner face 10 of the corresponding stator 9 into engagement.

The spray bar 1 further includes an outer tube 17 which surrounds and substantially encapsulates the inner tube 2 and associated rotors 5 and stators 9.

The outer tube 17 has various mounting holes 18 through which screws 19 can be inserted to lock each stator 9 into a fixed position with respect to the outer tube 17. Each stator 9 is locked into position such that an aperture 20 through the tube 17 is aligned with the stator port 13. A spray nozzle 21 is then attached to the outer tube 17 at each aperture 20 in alignment with the stator port 13 so that, in use, a fluid can pass through.

Finally, an actuator 22 is attached to the inner tube 2 and is configured and arranged to, in use, rotate the tube 2 relative to the outer tube 17 thereby moving the rotor port 8 and the stator port 13 into and out of alignment.

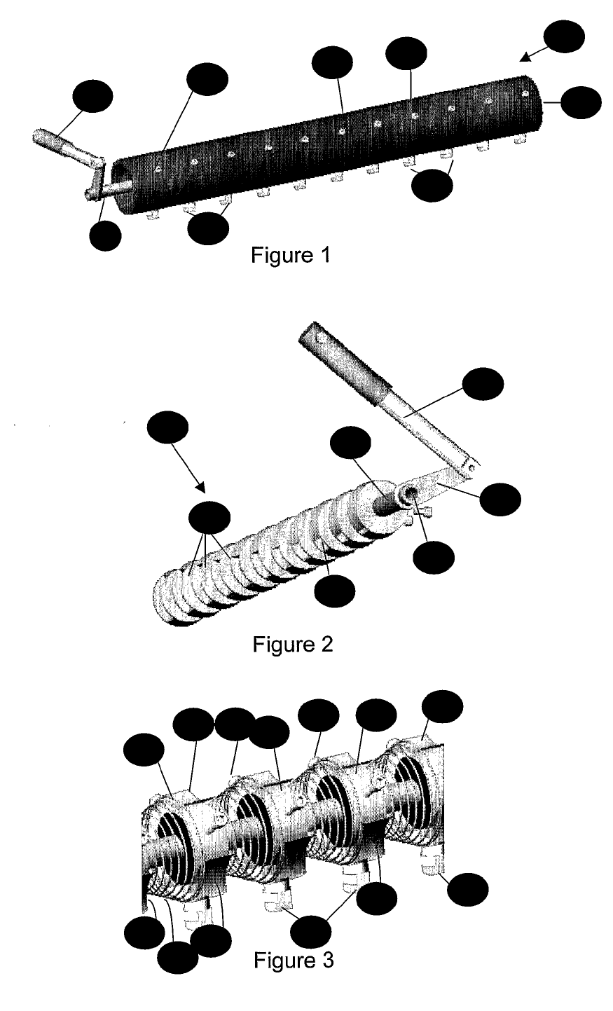

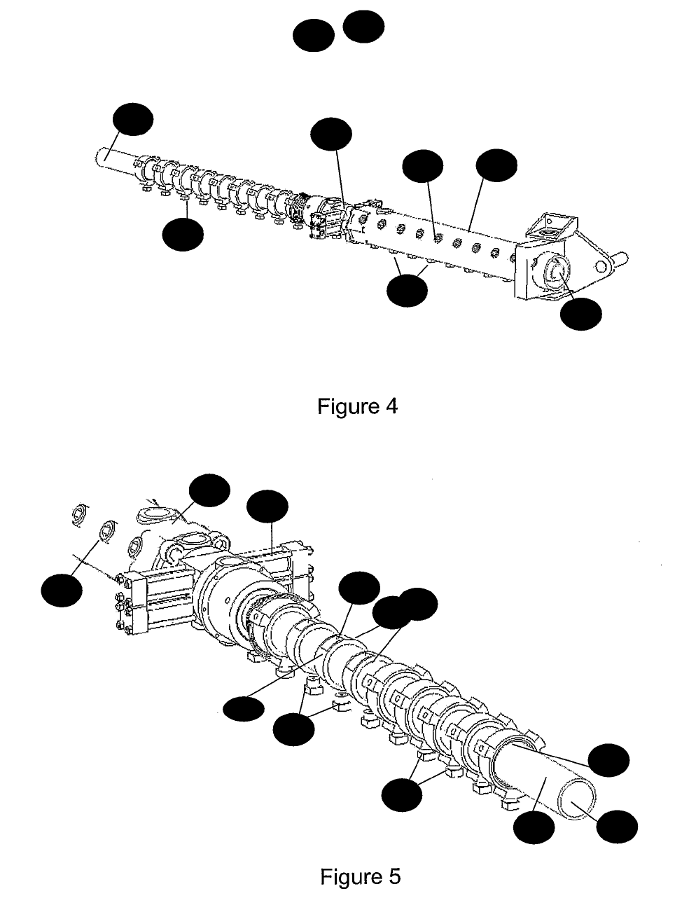

As shown in FIGS. 1 and 2, the actuator 22 can be in the form of a lever arm 23, or as shown in FIGS. 4 and 5, a hydraulic motor 24. Any other known form of actuator could be used. Operation of the actuator 22 can desirably be controlled remotely, such as from the cab of the vehicle on which the spray bar 1 is mounted.

In use, in the case of, for example, a bitumen spraying application, one or more spray bars 1 are mounted transversely off the rear of the vehicle. Hot fluid bitumen from the vehicle's holding tank is pumped into the fluid supply passage 3 of the tube 2 in the conventional manner. The actuator 22 is set to cause the ports 8 and 13 to align for at least some of the rotor/stator combinations so as to create the desired spray pattern. Bitumen is then caused to pass along the interior of the tube 2, through the ports 8, and where such ports 8 are aligned with corresponding ports 13, through the ports 13 and out through the spray nozzles 21.

When not spraying, the bitumen not passing out though the nozzles 21 returns to the holding tank by passing out of the remote end of the tube 2, into the space between the tube 2 and the tube 17, and back along the spray bar 1 passed the stators 9 via the sectors 12. From the end of the tube 17 the bitumen returns to the holding tank. Partial return is also effected when the aligned apertures are partially closed allowing a spray discharge rate lower than the supply rate.

It is a particular feature of the invention that the rate of discharge through any one nozzle can be controlled relative to other nozzles by selecting the size and shape of the apertures or ports associated with that particular nozzle. For example, in locations where it is desired to provide a higher rate of fluid discharge, the port associated with the particular nozzle can be wider or more elongated than other ports, providing a larger opening and hence a higher flow rate than the aligned ports associated with other nozzles.

Various patterns of port shape can be arranged in the rotors and/or stators (or in the apertures in the tubes themselves in a simple form of the invention) so that different relative rates of fluid application as between different nozzles can be achieved at different phases in the rotation of the inner tube relative to the outer tube.

All of this can be achieved very simply using a single actuator which is very easy to control by the operator at any point in time.

The spray bar according to the invention has significant advantages over existing spray bars due to a number of factors including the vast reduction in the number of components used for sequencing nozzles in order to control individual spray patterns. By way of example, a standard existing system uses one valve per nozzle, one pneumatic actuator to move the valve, and a pneumatic valve to control the actuator. In a typical bitumen application apparatus there are 44 such nozzles resulting in a high number of components necessary to control a standard width bar. By way of contrast, the system according to the invention utilises only one hydraulic rotary actuator and one hydraulic valve for each of the three sections of the bar typically used on a bitumen application vehicle.

A further advantage of the spray bar according to the invention is that all components are contained within the spray bar. For example, the valves are positioned and actuated within the bar itself. Prior art systems have all the componentry on the outside of the bar where it is easily damaged, particularly in a road making situation.

The use of hydraulic controls for the single hydraulic rotary actuator gives a very positive reaction with a high degree of controllability. By comparison, the pneumatic systems used in the prior art are reliant on constant air pressure and due to the inherent compressible nature of pneumatics, are rendered less controllable.

In prior art bitumen spray bar systems there are typically 88 or more pneumatic hoses associated with the spray bar which can easily be damaged or knocked off while in operation. The spray bar system according to the invention has only 6 hydraulic hoses which are able to be configured and designed to handle far more abuse in use.

There is also a problem with the use of pneumatic hoses in spraying bitumen which needs to be applied at high temperature to maintain the fluid state. Unfortunately, a temperature which is sufficiently high to melt the bitumen (typically 180° C.) is also hot enough to melt pneumatic hoses which are easily damaged by the extreme heat. Hydraulics are far more suitable in this application as the hydraulic hoses and oil are manufactured to withstand this heat, as are the rotary actuators. It would be extremely expensive and impractical to use hydraulic actuators in a conventional spray bar situation due to the high number of valves, actuators and hoses needed, but the simplified controls of the present invention allow the ready adaptation and economical use of hydraulic control equipment.

The present invention also permits simplified electronic control and therefore robust durability compared with the prior art systems. In a typical prior art bitumen spray bar application electronic control of the typical 44 pneumatic valves, which in turn control the pneumatic actuators and their respective bitumen valves, requires up to 88 wires from the control system at the front of the vehicle along with the other 20 or so electrical cables for the rest of the system giving in excess of 100 wires from the control system at the front the vehicle to the spray bar at the back. Damage to any one of these wires can render the whole system dysfunctional. The electronic system used to control the single hydraulic actuator in the spray bar according to the invention, only requires 6 wires for the hydraulic valves along with 9 from the feedback from the rotary position potentiometers.

It can therefore clearly be seen that the present invention not only provides superior control of patterns of fluid application, but also allows a considerably simpler and more reliable system to be utilised which reduces manufacturing costs as well as simplifying trouble-shooting in maintenance.

Where in the foregoing description reference has been made to integers or components having known equivalents then such equivalents are herein incorporated as if individually set forth.

Although this invention has been described by a way of example using possible embodiments, it is to be appreciated that improvements and/or modifications may be made thereto without departing from the scope of the present invention.

1-13. (canceled)

14. A spray bar for applying fluids onto an adjacent surface, said spray bar comprising:
an inner tube having a pathway defined longitudinally therethrough adapted to receive a fluid, and at least one aperture through the wall of said inner tube and in communication with said pathway;
an outer tube adapted to receive said inner tube therein, said outer tube having at least one aperture through the wall of said outer tube arranged such that said inner tube aperture and said outer tube aperture can be caused to align;
at least one spray nozzle mountable on the outer wall of said outer tube in communication with said outer tube aperture; and
an actuator means arranged to cause said inner tube to move relative to said outer tube thereby causing said apertures in said inner and outer tubes to move into and out of alignment.

15. The spray bar as set forth in claim 14, wherein said inner and outer tubes have multiple corresponding apertures spaced along their respective lengths, with a spray nozzle associated with each aperture in said outer tube.

16. The spray bar as set forth in claim 15 further including a return pathway for fluid that does not pass out through said spray nozzles in use, enabling the fluid to circulate.

17. The spray bar as set forth in claim 15, wherein said apertures in said outer tube are substantially the same size and shape, and are substantially equally spaced in a common axial plane along the length of said spray bar.

18. The spray bar as set forth in claim 15, wherein said apertures are of various sizes and shapes.

19. The spray bar as set forth in claim 18, wherein said apertures are located in different axial planes.

20. The spray bar as set forth in claim 13 further comprising a rotor mounted on said inner tube at said aperture, said rotor having a port extending radially from said aperture to the outer circumference of said rotor, said rotor being rotationally fixed onto said inner tube.

21. The spray bar as set forth in claim 20 further comprising an annular stator surrounded by said outer tube, said stator having an internal configuration substantially corresponding to the outer circumference of said rotor so as to receive and engage with said rotor, said stator having a port extending radially outwardly from its inner circumference to its outer circumference, said stator port being capable of alignment with said rotor port and with said outer tube aperture.

22. A spray bar comprising:
an inner tube through which a fluid can pass, said inner tube having at least one aperture in the wall thereof;
a rotor mounted on said inner tube at said aperture, said rotor having a port extending radially from said aperture to the outer circumference of said rotor, said rotor being rotationally fixed onto said inner tube;
an annular stator having an internal configuration substantially corresponding to the outer circumference of said rotor so as to receive and engage with said rotor, said stator having a port extending radially outwardly from its inner circumference to its outer circumference, said stator port being capable of alignment with said rotor port;
an outer tube surrounding said stator and being fixed thereto coaxially with said inner tube, said outer tube having an aperture therethrough in alignment with said stator port;
a spray nozzle attached to said outer tube in alignment with said stator port so that in use a fluid can pass therethrough; and
an actuator to rotate said inner tube relative to said outer tube thereby moving said rotor port and said stator port into and out of alignment.

23. The spray bar as set forth in claim 22, wherein there are multiple spray nozzles and corresponding rotor and stator ports disposed along the length of said spray bar.

24. The spray bar as set forth in claim 23, wherein said rotors are keyed to said inner tube to prevent rotation, but are substantially free floating along the length of said inner tube, axially located via a spring means.

25. The spray bar as set forth in claim 24, wherein the outer periphery of said rotor and the inner face of said stator are conical, and said spring means has a first end which engages said rotor and another end which engages said stator, thereby applying pressure to bias the circumferential face of said rotor and the inner face of said corresponding stator into engagement.

26. The spray bar as set forth in claim 25, wherein said stators do not occupy the entire cross section of said outer tube, thereby providing a return flow path for unused fluid back along the length of said outer tube.

27. The spray bar as set forth in claim 26, wherein one or more said stator and rotor combinations have two or more ports, either offset radially, or offset longitudinally.

28. The spray bar as set forth in claim 27, wherein said spray bar has multiple said rotor and stator combinations, with some of said rotors having different port configurations than other said rotors, such that partial rotation of said inner tube can bring some of said rotor ports out of alignment with their said corresponding stator port, but other said rotor ports will remain in alignment with their said corresponding stator ports.

29. The spray bar as set forth in claim 22, wherein said outer tube further comprising mounting holes through which fasteners are inserted to lock said stator into a fixed position with respect to said outer tube.

30. A spray bar comprising:
an inner tube having a pathway defined longitudinally therethrough adapted to receive a fluid, and a plurality of apertures through the wall of said inner tube and in communication with said pathway;
a plurality of rotors mounted on said inner tube at said aperture, each of said rotors having a port extending radially from said corresponding aperture to the outer circumference of said rotor, said rotors being rotationally fixed onto said inner tube;
a keying arrangement adapted to prevent each of said rotors from rotating;
a spring means axially located to each of said rotors and adapted to alloy said rotors float freely along the length of said inner tube;
a plurality of stators each having an internal configuration substantially corresponding to the outer circumference of said rotors so as to receive and engage with said rotors, said stators each having a port extending radially outwardly from its inner circumference to its outer circumference, said stator port being capable of alignment with said rotor port;
an outer tube surrounding said stator and being fixed thereto coaxially with said inner tube, said outer tube having an aperture therethrough in alignment with said stator port;
a plurality of spray nozzles attached to said outer tube in alignment with said stator ports so that in use a fluid can pass therethrough; and
an actuator to rotate said inner tube relative to said outer tube thereby moving said rotor port and said stator port into and out of alignment;
wherein the outer periphery of said rotors and the inner face of said stators are conical, and said spring means has a first end which engages said rotor and another end which engages said stator, thereby applying pressure to bias the circumferential face of said rotor and the inner face of said corresponding stator into engagement;
wherein said stators do not occupy the entire cross section of said outer tube, thereby providing a return flow path for unused fluid back along the length of said outer tube.

31. The spray bar as set forth in claim 30, wherein one or more said stator and rotor combinations have two or more ports, either offset radially, or offset longitudinally.

32. The spray bar as set forth in claim 31, wherein said spray bar has multiple said rotor and stator combinations, with some of said rotors having different port configurations than other said rotors, such that partial rotation of said inner tube can bring some of said rotor ports out of alignment with their said corresponding stator port, but other said rotor ports will remain in alignment with their said corresponding stator ports.

33. The spray bar as set forth in claim 32, wherein said outer tube further comprising mounting holes through which fasteners are inserted to lock said stator into a fixed position with respect to said outer tube.
